(19) United States
(12) Patent Application Publication
(10) Pub. No.: US 2024/0330358 A1
(43) Pub. Date: Oct. 3, 2024

(54) COMPUTERIZED SYSTEM FOR DETERMINING COMMON INTEREST USING IMAGE-BASED USER PREFERENCES

(71) Applicant: Flikah, LLC, Greenville, SC (US)

(72) Inventor: Spencer Wilkinson, Greenville, SC (US)

(73) Assignee: Flikah, LLC, Greenville, SC (US)

(21) Appl. No.: 18/421,060

(22) Filed: Jan. 24, 2024

Related U.S. Application Data
(60) Provisional application No. 63/455,164, filed on Mar. 28, 2023.

(51) Int. Cl. G06F 16/535; G06F 16/538; G06F 16/54

(52) U.S. Cl. CPC G06F 16/535; G06F 16/538; G06F 16/54

(57) ABSTRACT

The present invention relates to a system and method for selecting and ranking objects according to image based preferences. The system creates a set of first selected objects based upon a first preference received from a first user regarding objects depicted in object images. The system allows for a second user to input a second preference relating to the set of first selected objects. The system may then rank the objects contained in the set of first selected objects based upon the first and second preferences received. In alternate embodiments, the system may create a set of first selected objects according to a first preference received from a first user and may create a set of second selected objects according to a second preference received from a second user. The system may then create a set of third selected objects according to the users' third and fourth preference.

### RELATED APPLICATIONS

This application claims priority to provisional patent application No. 63/455,164.

### BACKGROUND OF THE INVENTION

### 1) Field of the Invention

The present invention generally relates to systems and methods for determining common interest using image-based user preferences. The invention also relates to systems and methods for suggestion based reinforcement learning (SbRL) controller using pre-trained image recognition.

### 2) DESCRIPTION OF THE RELATED ART

Computing technologies and applications continue to advance at a rapid pace. Examples of computing devices may include a range of devices from mobile hand-held computing devices to large multi-processor computer systems. Computing devices are increasingly linked with other devices such as appliances, embedded systems, servers, websites, databases, search engines, etc.

In some examples, computing devices may be used for work, entertainment, and/or commerce. For example, a computing device may be utilized to find and review goods and services before purchasing such goods and services. Benefits may be realized if improvements were made to the process of browsing items on a computer device.

Therefore, it is one objective to provide a system for learning image-based user preferences capable of selecting object images based upon the user preferences and showing those images to the user. It is another objective of the system to rank the objects for which user input has been received according to the user input and/or preferences. It is also an objective of the system to allow more than one user to provide input on the selected images and to rank the objects based upon the input received from each user regarding the object images. It is another objective of the system to share the images, user input and/or ranking with third parties.

It is an objective to provide a computerized system for buying and selling real estate that allows users to search for images of real estate based on selection critria provided by the user. It is another objective of the system to receive user input regarding the images and to select additional real estate and to display images of the selected real estate to the user based upon the user input provided. It is another object of the system to rank the real estate being bought or sold based upon the user input that has been received to provide a list of the user's preferred real estate. It is another object to allow more than one user to provide input on the selected images and to rank the real estate being bought or sold based upon the input of each user to provide a list of the group's preferred real estate. It is another objective of the system to share the real estate listings with a third party such as a real estate agent.

### BRIEF SUMMARY OF THE INVENTION

The above objectives are accomplished by providing a computerized system for determining common interest using image-based user preferences comprising: a server having an object database wherein each object represented in the object database is associated with a plurality of object images wherein each object image represents an attribute of the object; a first machine learning system in communications with the server and adapted to receive a set of selection criteria, retrieve a first set of objects from the object database, display a first set of object images, receive a first preference for at least one of the images in the first set of object images displayed, determine a first preference score according to the first preference received, create a set of first selected objects according to a first preference score, provide the first preference score to a second machine learning system; and, wherein the second machine learning system is adapted to display the first set object images, receive a second preference for at least one of the images in the first set of object images displayed, determine a second preference score according to the second preference received for at least one image in the first set of object images, create a set of second selected objects according to the first preference score and the second preference score, wherein the set of second selected objects represents objects for which the first preference and the second preference are consistent.

In at least one embodiment, the first machine learning system is adapted to assign a first ranking to each of the objects within the set of first selected objects according to the first preference score and the second machine learning system is adapted to assign a second ranking to each of the objects within the set of first selected objects according to the second preference score. In a least one embodiment, the second machine learning system is also adapted to assign a third ranking to each of the objects within the set of second selected objects according to an aggregate of the first preference score and the second preference score.

In at least one embodiment, the objects are physical structures and the images are images of at least a portion of a room in the physical structure. In other embodiments, however, the objects could be any physical object or good such as vehicles, clothing, electronics and/or consumer goods. In further embodiments, the objects could be establishments and/or businesses such as restaurants or other businesses that provide services.

In one embodiment, one or both of the first preference and the second preference may be determined according to a swipe, flick or other motion across the screen of the computer system. In other embodiments, one or both of the first and second preference could be determined by the dwell time, and/or the length of time that has elapsed between when an image is first shown to a user and when user input is received for such an image, including a request to show the next image. In such an embodiment the dwell time could be the time that has elapsed between when a first image of the first set of object images is displayed and when a user input is received for the first image.

In another embodiment, the computerized system comprises: a processor; memory; instructions stored in the memory that when executed by the processor cause a first machine learning system to: display a first set of images wherein the first set of images comprises a plurality of images, each of which is associated with a feature of a physical object, receive a first preference ate least one image in the first set of images displayed, determine a first preference score according to the first preference received, provide to a second learning system the first set of images and the first preference score; and, instructions stored in the memory that when executed by the processor cause the second machine learning system to display the first set of images, receive a second preference for at least one image of the first set of images displayed, determine a second preference score according to the second preference received, order the images in the first set of images according to the first preference score and the second preference score.

In such an embodiment, the order of the images in the first set of images is determined, at least in part, according to a consistency between the first preference and the second preference. In at least one embodiment, the first machine learning system is adapted to assign a first ranking to each of the objects associated the set of first set of images according to the first preference score and wherein the second machine learning system is adapted to assign a second ranking to each of the objects associated with the set of first set of images according to the second preference score.

In another embodiment, the computerized system for determining common interest in image-based user preferences comprises: a server having an object database wherein each object represented in the object database is associated with a set of object images wherein each object image represents an attribute of the object; a first machine learning system in communications with the server and adapted to receive a set of selection criteria, retrieve a first set of objects from the object database, display a first set of images associated with the first set of objects, receive a first preference for each image in the first set of images displayed, determine a first preference score according to the first preference received, provide the first preference score to a second machine learning system; and, wherein the second machine learning system is adapted to receive the receive the first preference score, select a second set of objects according to the first preference score, display a second set of images associated with the second set of objects, receive a second preference for each image in the second set of images displayed, determine a second preference score according to the second preference received for each image in the first subset of images, create a set of selected objects according to the second preference score and the first preference score, wherein the set of selected objects represents objects for which the first preference and the second preference are consistent.

In at least one embodiment, the set of selection criteria received by the first machine learning system is modified according to the first preference score so that the objects retrieved in response to the selection criteria are retrieved, at least in part, according to the first preference received by the first machine learning system. In another embodiment, the set of selection criteria is modified according to the similarities in the first preference and the second preference so that the objects retrieved in response to the selection criteria are retrieved, at least in part, according to the first preference and the second preference.

Any of the embodiments of the invention discussed herein, including those discussed above, could have any or all the functionality and/or structural components discussed herein.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a block diagram of an example of an electronic device for creating a user profile using image-based user input;

FIG. 2 is a flow diagram illustrating an example method for creating a user profile using image-based user input;

FIG. 3 is a block diagram of another example of a system for creating a user profile based on user input;

FIG. 4 depicts an example of a user interface of a computing device used to prompt user input;

FIG. 5 depicts examples of computing device displays used to prompt user input and show a user profile;

FIG. 6 depicts a high-level diagram for creating a user profile based on user input;

FIG. 7 depicts another example diagram of creating a user profile and allowing a user to share the profile;

FIG. 8 illustrates various components that may be utilized in an electronic device;

and,

FIG. 9A-B is a flow diagram illustrating an example of the creation of one or more sets of selected objects and ranking the objects within the sets of selected objects based upon one or more user preferences.

### DETAILED DESCRIPTION OF THE INVENTION

With reference to the drawings, the invention will now be described in more detail. Various examples of the systems and methods are now described with reference to the Figures. The examples of the present systems and methods, as generally described and illustrated in the Figures herein, could be arranged and designed in a wide variety of different configurations. Thus, the following more detailed description of several examples, as represented in the Figures, is not intended to limit the scope of the systems and methods, as claimed, but is merely representative of the various configurations of the systems and methods.

Systems and methods to obtain and display user preferences are used to suggest to a user an item in which the user may have interest. In the current state of the art, obtaining user preferences is generally done using user input data collected using basic structure data language. For example, a real estate database may use basic structure data language to provide data concerning real estate property. The data may include the number of bedrooms, the address, the number of stories, the acreage of the property, the square footage of the building. This offers limited search functionality and mobile experience. It is based on low-quality internet data exchange (IDX) which results in poor search functionality, eliminating Natural Language Processing (NLP). The current real estate marketplace platforms are stuck in the past, being product-centric. They focus on the house, rather than being customer-centric and focused on the buyer, seller, and realtor. The present invention uses image recognition to gather unstructured data to create user preferences. Gathering unstructured data may be done by tagging images to identify features. The present invention offers an engaging mobile experience, uses natural language search, uses preference-based reinforcement learning for recommendations, uses pre-trained image recognition, allows for profile editing and sharing so that users can edit and share their preferences, and provides user insights to service providers. The present invention also allows for the real estate to be automatically ranked according to the preference of one or more users such that the ranking can represent the preferences of a single user or the overlapping preferences of the group of users. The present invention uses artificial intelligence (AI) and machine learning to enrich the current data set and enables better search functionality and recommendations. The present invention uses a suggestive algorithm controlled by users and built on their preferences. User preferences are converted into useful information for service providers.

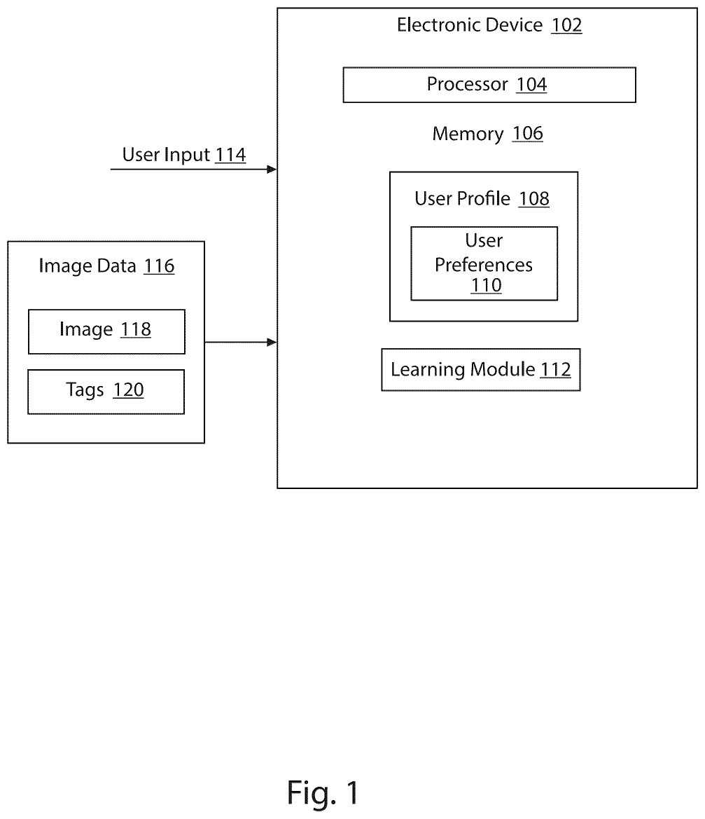

FIG. 1 is a block diagram of an example of an electronic device 102 for creating a user profile 108 using image-based user input 114. An electronic device 102 may include a processor 104 and/or logic circuitry. Examples of an electronic device 102 may include a server (e.g., a web server, a set of servers, blade server(s), server bank, etc.), a desktop computer(s), a laptop computer(s), a tablet device(s), and/or a smartphone(s), etc.

The electronic device 102 may include memory 106. The electronic device 102 may also include additional components (not shown) and/or some of the components described herein may be removed and/or modified without departing from the scope of this disclosure.

The processor 104 may be a central processing unit (CPU), logic circuitry, a semiconductor-based microprocessor, a digital signal processor (DSP), graphics processing unit (GPU), field-programmable gate array (FPGA), an application-specific integrated circuit (ASIC), and/or other hardware device suitable for retrieval and execution of instructions stored in the memory 106. The processor 104 may fetch, decode, and/or execute instructions stored in the memory 106. In some examples, the processor 104 may perform one, some, or all of the operations, aspects, etc., described in relation to the figures. For example, the memory 106 may store instructions for one or more of the operations, aspects, etc., described in relation to one or more of the figures. The processor 104 may be coupled to (e.g., may be in electronic communication with) the memory. In some examples, one or more of the operations, functions, aspects, etc., described herein in terms of instructions executed on a processor 104 may instead be implemented directly in hardware without instructions. For instance, the processor 104 may be a state machine, logic circuitry, ASIC, etc., implemented without instructions to perform one or more of the operations, functions, aspects, etc., described herein.

The memory 106 may be an electronic, magnetic, optical, and/or other physical storage device that contains or stores electronic data (e.g., instructions and/or information). In some examples, memory 106 (e.g., memory) may be Random Access Memory (RAM), magnetoresistive random-access memory (MRAM), Dynamic Random Access Memory (DRAM), phase change RAM (PCRAM), memristor, non-volatile memory, Read-Only Memory (ROM), Erasable Programmable Read-Only Memory (EPROM), Electrically Erasable Programmable Read-Only Memory (EEPROM), and/or flash memory, etc. The memory 106 may be, for example, RAM, EEPROM, a storage device, a solid-state drive (SSD), a magnetic drive, an optical disc, and/or the like. In some examples, the memory 106 may be volatile and/or non-volatile memory, such as DRAM, EEPROM, MRAM, PCRAM, memristor, flash memory, and/or the like. In some examples, the memory 106 may be a non-transitory tangible machine-readable storage medium. In some examples, the memory 106 may include multiple devices. In some examples, the memory 106 of the electronic device 102 may store user profile 108, user input 114, and a learning module 112.

In some examples, the electronic device 102 may include hardware (e.g., circuitry, ports, connectors, antennas, etc.) and/or machine-readable instructions to enable the processor to communicate with various input and/or output devices, such as a keyboard, a mouse, a display, another apparatus, electronic device, computing device, etc., through which a user may input instructions and/or information into the electronic device.

The memory 106 may include instructions that when executed cause the processor to display image data 116. The image data may be displayed in response to user input 114 such as selection criteria and/or preferences received by processor 104. Image data may include an image 118 and the image 118 may be associated with one or more tags 120. Each tag 120 may identify an object feature shown in the image 118. The images may be pre-inventoried by a pre-trained image recognition system so that object features are tagged 120 quickly and efficiently. The processor may receive user input 114 for the image 118 indicating a user preference 110 relating to at least one object feature and/or tag 120. User input 114 may be in the form of user swiping or flicking on the surface of the display of the electronic device 102. The processor 104 may store the user preference 110 in a user profile 108 in the memory 106. In one example, the processor may sequentially cycle through a plurality of object images 118 to receive user input 114 for each of the plurality of images 118. The processor 104 may display the user profile 108. The processor 104 may receive additional user input 114 which may alter or edit the user profile 108. As such, the user profile 108 may be updated continuously based on ongoing user input 114. The processor 104 may then store an updated or edited user profile 108 including the alterations or edits to the user profile 108. The user profile 108 may be made available for sharing by the user. The plurality of images 118 may be related to different areas of interest including, including but not limited to, real estate, clothing, automobiles, electronics, consumer products and/or business establishments. The instructions may further cause the processor 104 to display items from a global computer network and display item images based on the user profile 108 so that the user may browse the items. The way the item images are displayed may be based on the user profile 108 and may include changing an order the item images are shown, not displaying a certain item image, or altering the certain item image before displaying the certain item image.

The electronic device 102 may include additional components (not shown) and/or some of the components described herein may be removed and/or modified without departing from the scope of this disclosure.

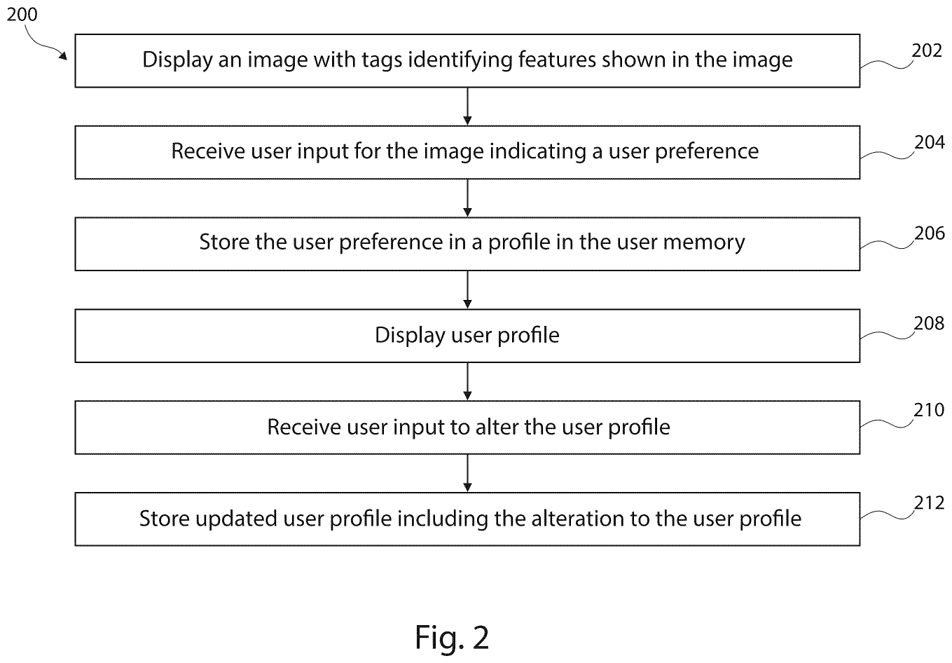

FIG. 2 is a flow diagram 200 illustrating an example method for learning image-based user input. The method may include displaying 202 an image, whether the image is selected randomly or in response to user input, including selection critria and/or user preferences. The image may be associated with one or mor tags. Each tag may identify a feature shown in the image and associated with a physical object. User input may be received 204 for the image indicating a user preference relating to at least one tag of the one or more tags. In one example, user input may be received by the user swiping or flicking the surface of a display of an electronic device. User preferences based on user input may be stored 206 in a user profile in memory. The method may also include sequential cycling through a plurality of images and receiving user input for each of the plurality of images and storing additional user preferences in the user profile. The plurality of images may be related to different areas of interest including, for example, real estate, clothing, and automobiles. The user profile may be displayed 208, and the user may alter 210 or edit the user profile. The method may also include receiving 210 user input to alter or edit the user profile and storing an updated user profile including the alteration or edits to the user profile. The user profile may be shared 212 by the user. The user profile may be anonymous to protect privacy. The method may further include displaying items from a global computer network and displaying item images based on the user profile so that the user may browse the items. The way the item images are displayed may be based on the user profile and may include changing an order the item images are shown, not displaying a certain item image, or altering the certain item image before displaying the certain item image. As discussed below, the system may select images of objects to be displayed according to one or more preferences received from a user. They system may include a machine learning system such as a suggestion-based reinforcement learning (SbRL) controller that accesses one or more user preferences from one or more user profiles and utilizes that data to select and display images of objects to the user that are consistent with the user preferences.

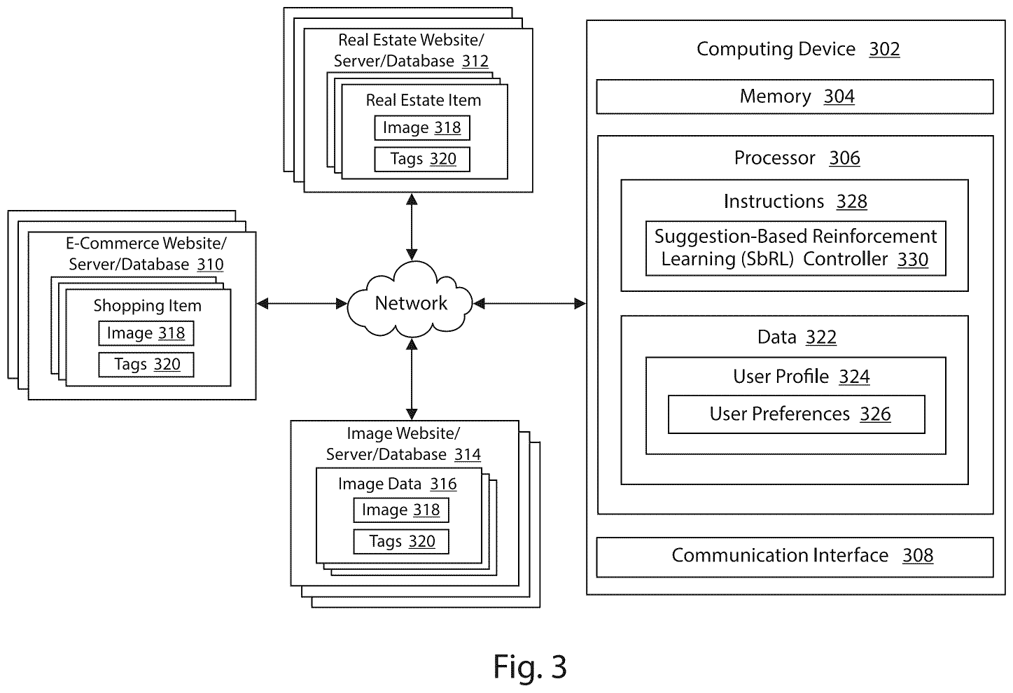

FIG. 3 is a schematic block diagram of another example of a system for creating a user profile based on data received from a user. One example of an electronic device may be a computing device 302. The computing device 302 may include a processor 304, memory 306, and/or a communication interface 308. The computing device 302 may include additional components (not shown) and/or some of the components described herein may be removed and/or modified without departing from the scope of this disclosure.

In some examples, the computing device 302 may include a communication 308 interface through which the computing device 302 (e.g., processor 304) may communicate with an external device or devices. The communication interface 308 may include hardware (e.g., a network interface card) and/or machine-readable instructions to enable the processor to communicate with one or more external devices (e.g., the computing device 302, e-commerce website(s)/server(s)/database(s) 310, real estate website(s)/server(s)/database(s) 312, and/or image server(s)/database(s)) 314. One example of a real estate website/server/database 312 is the Multiple Listing Service (MLS) database. For instance, the communication interface 308 may include a wired communication interface(s) and/or wireless communication interface(s) for linking to an electronic device(s) (e.g., switch(es), router(s), server(s), and/or computer(s), etc.). Examples of a wired communication interface may include an Ethernet interface, Universal Serial Bus (USB) interface, fiber interface, Lightning® interface, etc. In some examples, the computing device 302 may include a wireless communication interface to send and/or receive wireless (e.g., radio frequency (RF)) signals. Examples of wireless communication interfaces may include an Institute of Electrical and Electronics Engineers (IEEE®) 802.11 (WI-FI®) interface, Bluetooth® interface, cellular (e.g., 3G, Long-Term Evolution (LTE®), 4G, 5G, etc.) interface, etc.

In some examples, the computing device 302 may receive image data 316 including image(s) 318 and tag(s) 320 from an image server/database 314. In other examples, the computing device may receive image data 316 including image(s) 318 and tag(s) 320 from specific kinds of website(s)/server(s)/database(s), for example, e-commerce website(s)/server(s)/database(s) 310 or real estate website(s)/server(s)/database(s) 312. The image data 318 may be displayed on the computing device 302 for a user to input user preferences. User input may be in the form of swiping, tapping, or flicking on the display of the computing device 302 to indicate user preference of an image 318 or a tagged feature. Data 322 received from user includes user preferences 326 and may be stored in a user profile 324 in the memory 306. The memory 306 may include instructions 328. The instructions 328 may include a machine learning system such as a suggestion-based reinforcement learning (SbRL) controller 330 that when executed accesses data 322 included in the user profile 324 and uses that data 322 to suggest images to the user by showing the images on the display of the computing device. The suggestions may include displaying images which include tagged features that the user prefers and not displaying images which include tagged features that the user does not prefer.

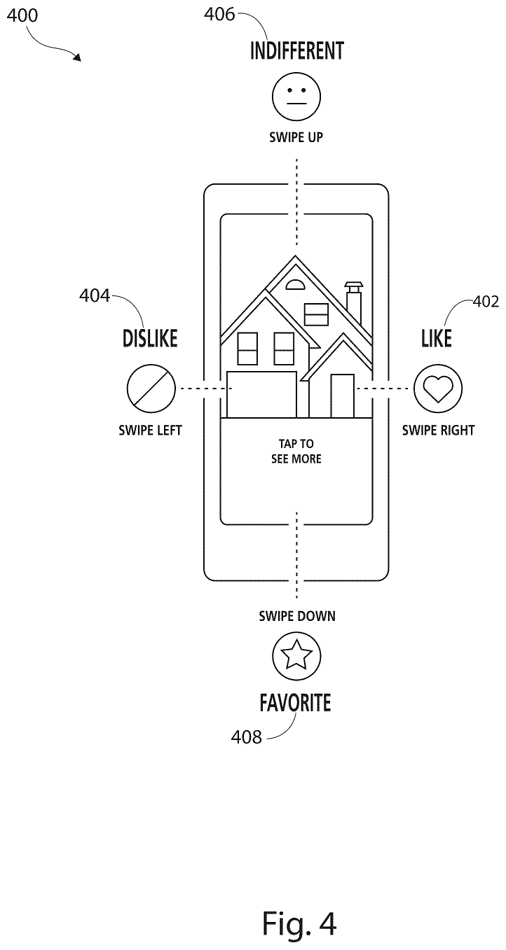

FIG. 4 depicts an example of a user interface display for a computing device 400, such as a cell phone or mobile phone used to prompt user input. When the user opens an image on the device, the device displays a digital representation of an object in the form of an image of the object. The image shown on FIG. 4 is an example of a real estate item. The user may indicate preferences related to a tagged feature of the object that is displayed in the image. For example, the user may swipe right 402 on the display of the device if the user likes a feature of the object depicted in the image, the user may swipe left 404 if the user dislikes a feature of the object depicted in image, the user may swipe up 406 if the user is indifferent about a feature of the object depicted in the image and the user may swipe down 408 if the user strongly prefers a feature of the object depicted in the image. What information a swipe indicates and which direction indicates what information may be modified without departing from the scope of this disclosure. For example, in another embodiment, if a user swipes down, the instructions may be programmed to interpret that to mean the user wants to wait to provide input on that feature until later. In alternate embodiments, the user input may be in the form of tapping, pressing, and/or flicking the display. In alternate embodiments, the user preference could be in the form of depressing a button or making a selection with a device such as a mouse, keyboard and/or keypad. In yet another embodiment, the user preference could be according, at least in part to the length of time that has elapsed between when a first image of the first set of object images is displayed and when a user input is received for the first image and/or when the user request that a different image be displayed.

A suggestion-based reinforcement learning (SbRL) controller using pre-trained image recognition may be used to collect user input and create a user profile. Reinforcement learning is a type of machine learning that involves an agent learning through trial and error, in which it receives rewards or penalties for certain actions taken in a given environment. In the context of real estate, preference-based reinforcement learning could be used to optimize decision-making related to property investments or management. Some potential advantages of using this approach could include:
improved efficiency: reinforcement learning algorithms can continuously learn and adapt over time, allowing them to potentially make better decisions more quickly than humans;
reduced risk: by learning from past experiences and adjusting their actions accordingly, reinforcement learning algorithms can potentially reduce the risk of making poor decisions;
increased flexibility: preference-based reinforcement learning algorithms can adapt to changing circumstances and preferences, allowing them to potentially make better decisions in dynamic environments;
improved performance: by continuously learning and adapting, reinforcement learning algorithms can potentially outperform humans or other decision-making methods over time.

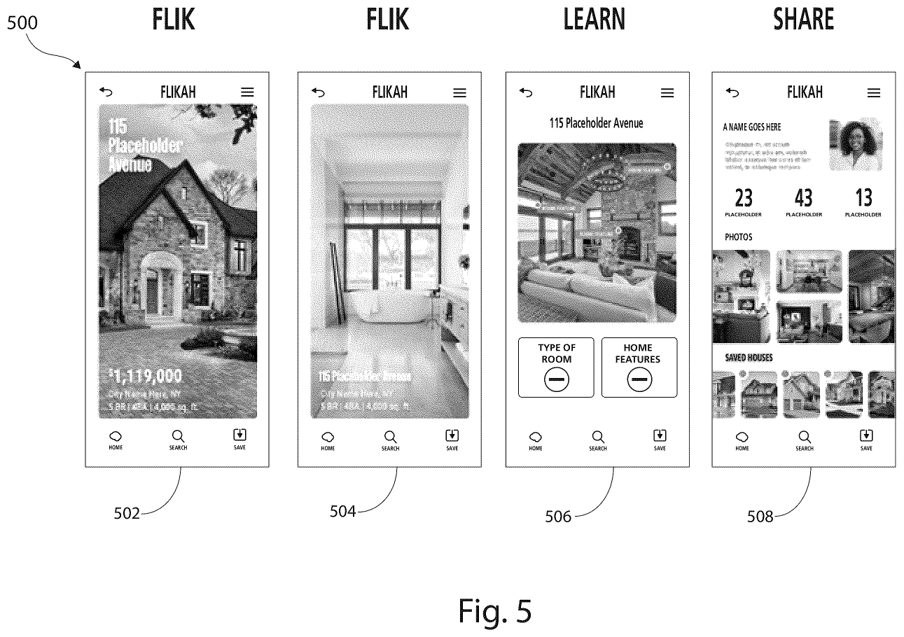

FIG. 5 depicts examples of computing device displays 500 used to prompt user input and show user profile. The images shown in FIG. 5 relate to the area of real estate. The images in 502 and 504 are examples of images from a first set of objects retrieved from an object database and which are displayed to a user to prompt the user to provide input. The image in 506 shows a user an example of features of an object that corresponds to, and was selected by the system according to, search criteria and/or preferences indicated by user input. The user may provide additional input. User input is used to create a user profile such as the user profile shown in 508. The user profile may include one or more sets of selected objects, which were created according to one or more user profiles and/or user preferences. The user profile and/or the one or more sets of selected objects is available for sharing by the user. Allowing the user to share a user profile and/or a set of selected objects is significant because it allows the user to collaborate with other interested parties to create one or more subsequent sets of selected objects created pursuant to the user profile and/or user preference of the user with whom the initial user profile and/or set of selected objects is shared. The user may share the user profile with another family member or business associate who has an interest in searching for a product. The user may share the user profile with service providers so service providers may have immediate information about the user's preferences so service providers may better assist the user in finding the most suitable product.

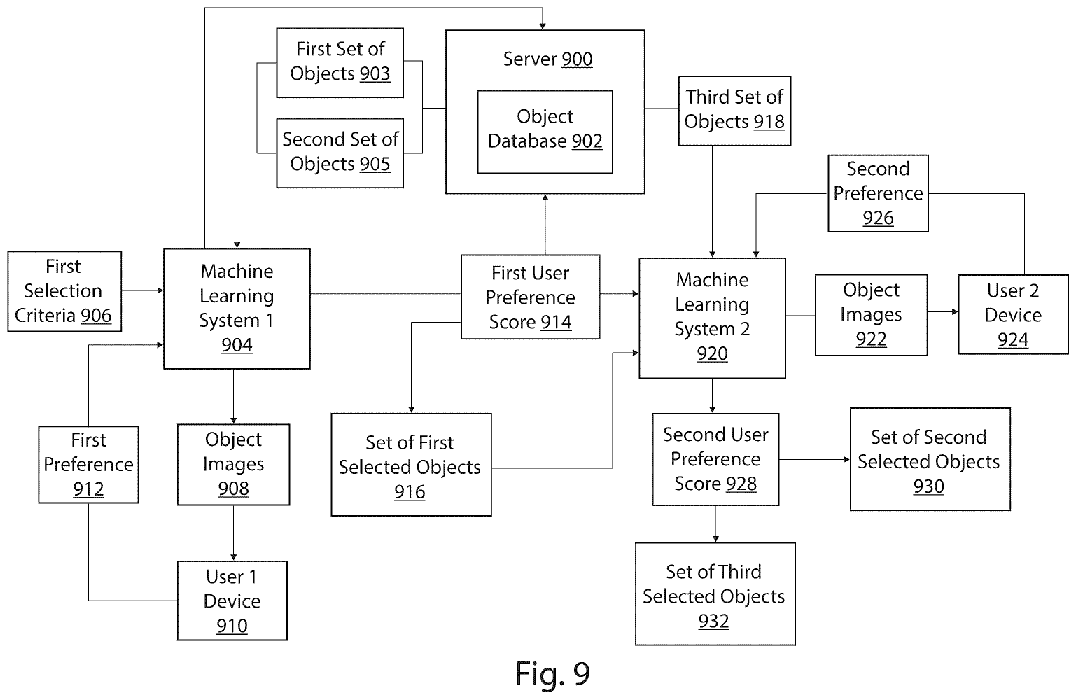

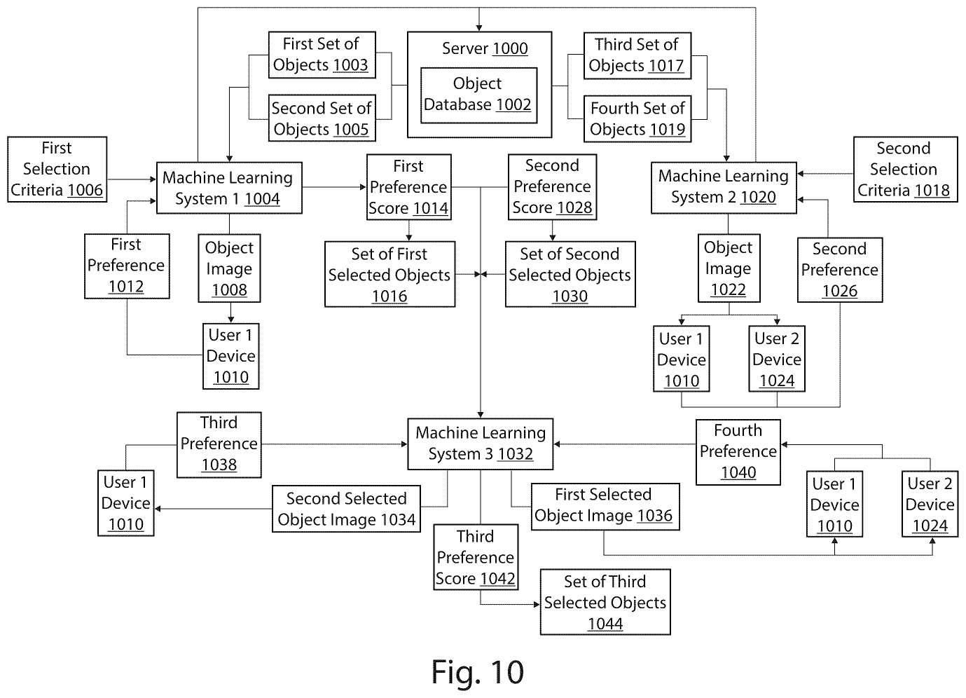

As will be discussed in association with FIGS. 9A-B, the system is capable of creating a set of first selected objects according to the user profile and/or user preference received from a first user. The system may rank the objects included in the set of first selected objects based upon the user profile and/or user preference of the first user wherein the objects are ranked such that the objects that are most consistent with the first user's profile and/or user preference are ranked highest and the objects that are least consistent with the first user's profile and/or user preference are ranked lowest. The system may also create a second set of selected objects according to the user profile and/or user preference received from a second user. The system may rank the objects included in the second set of first selected objects based upon the second user's profile and/or user preference wherein the objects are ranked such that the objects that are most consistent with the second user's profile and/or user preference are ranked highest and the objects that are least consistent with the second user's profile and/or user preference are ranked lowest. The system is also capable of creating a third set of selected objects according to the user profile and/or user preference received from both the first and the second user and/or group of users with whom the profile and/or first set of selected objects is shared. The system may rank the objects included in the third set of first selected objects according to the user profile and/or user preference of the first and second user and/or group of users wherein the objects are ranked such that the objects that are most consistent with group's preferences are ranked highest and the objects that are least consistent with the group's preference are ranked lowest.

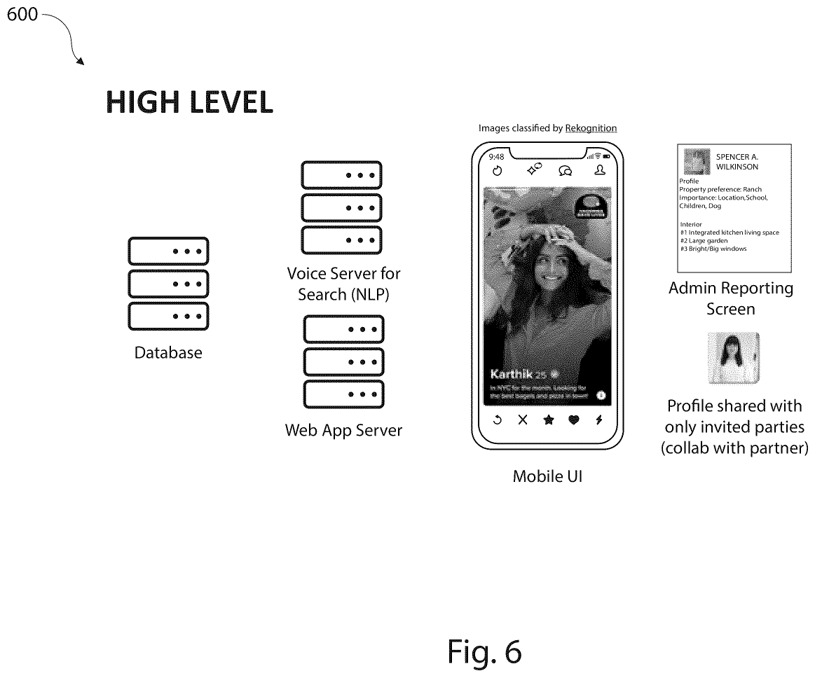

FIG. 6 depicts an example method 600 for creating a user profile based on user input. Image data is obtained from a database housed in a server that is in communications with the present invention. The images are inventoried by a pre-trained image recognition system so different features of the images are tagged in an automated fashion. A user may search the data included in the database using voice server or natural language processing (NLP) technology. The user may also search the data using a web application server. User input is received by displaying images to a user and the user indicating their preferences. A user profile is created from user input. The user profile is available for sharing by the user.

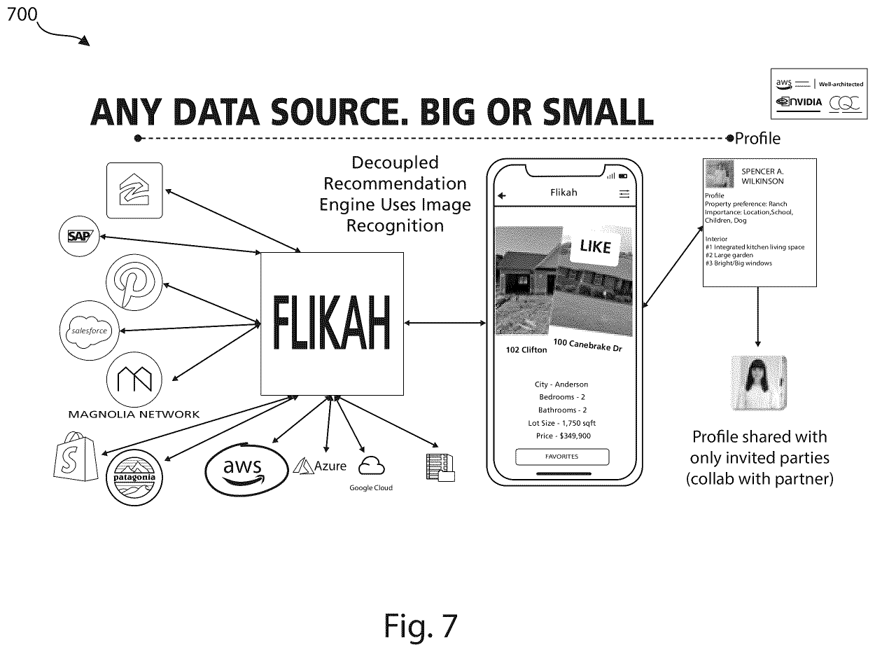

FIG. 7 depicts another example method 700 for creating a user profile based on user input and allowing the user to share their user profile. The figure shows examples of different databases available on the internet. The user profile may be available for use to filter images and display images according to user preferences for use with data in any database the user accesses.

A user may search for a desired item or object. Items may be real estate properties, clothing items, automobiles, etc. A user may use natural language (voice or text) to search for desired items. The search will return images, attributes, and descriptions of desired items or objects. User searches may also be conducted through a pre-trained generative chat interface, such as ChatGPT and ChatGPT-4.

The user may indicate whether an object or features of the object depicted in the image are liked or disliked or the user may indicate indifference or a strong preference of the object or object feature depicted in the image. User input may be received by the user swiping or flicking right, left, up or down.

Images liked, disliked and indifferent will go through image recognition processing to identify attributes of the object depicted in the image. These attributes are then used to build a profile of the user's likes and dislikes. This profile can be edited by the user to ensure they are matched to user preferences. Access to a read-only version of the user profile (or a portion of it) may be shared by the user.

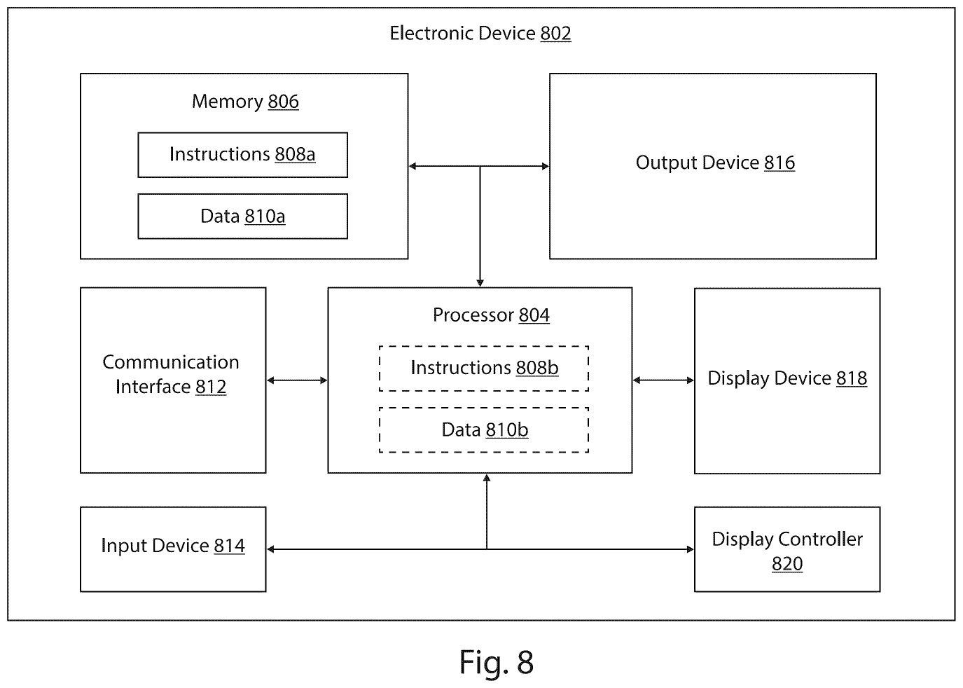

FIG. 8 illustrates various components that may be utilized in an electronic device 802. The electronic device 802 may be configured in accordance with one or more of the computing devices described herein.

The electronic device 802 may include a processor 804 and memory 806. The memory 806 may include instructions 808a and data 810a. The processor 804 controls the operation of the electronic device 802 and may be, for example, a microprocessor, a microcontroller, a digital signal processor (DSP), or other device. The processor 804 may perform logical and arithmetic operations based on program instructions 808b and/or data 810b received from the memory 806.

The electronic device 802 may include one or more communication interfaces 812 for communicating with other electronic devices. The communication interfaces 812 may be based on wired communication technology, wireless communication technology, or both. Examples of different types of communication interfaces 812 include a serial port, a parallel port, a Universal Serial Bus (USB), an Ethernet adapter, an Institute of Electrical and Electronics Engineers (IEEE) bus interface, a small computer system interface (Scsn bus interface, an infrared (IR) communication port, a Bluetooth wireless communication adapter and so forth.

The electronic device 802 typically may include one or more input devices 814 and one or more output devices 816. Examples of different kinds of input devices 814 include a keyboard, mouse, microphone, remote control device, button, joystick, trackball, touchpad, lightpen, etc. Examples of different kinds of output devices 816 include a speaker, printer, etc. One specific type of output device 816 that may be included in a computer system is a display device 818. Display devices used with configurations disclosed herein may utilize any suitable image projection technology, such as liquid crystal display (LCD), light-emitting diode (LED), gas plasma, electroluminescence, a cathode ray tube (CRT) or the like.

A display controller 820 may also be provided for converting data stored in the memory into text, graphics and/or moving images (as appropriate) shown on the display device. Of course, FIG. 8 illustrates only one possible configuration of an electronic device 802. Various other architectures and components may be utilized.

Referring now to FIGS. 9-10, the manner in which multiple individuals may collaborate on liking and disliking objects, creating a joint profile and/or creating sets of selected objects according to the preference of one or more of the individuals is more fully described. A first machine learning system 904 is in communication with an object database 902, which is housed in an object server 900. The first machine learning system may retrieve a first set of objects 903 from the object database according to a first set of selection criteria 906 received by the first machine learning system 904. Alternatively, the first machine learning system may randomly select the first set of objects 903 from the object database 902. The first machine learning system may then display to a first device 910 the object images 908 associated with the retrieved objects 903. The first user may then provide a first user input 912 via the first user device 910. Such input may constitute a first preference, which may be input in any of the manners discussed herein or that would be generally known in the art. The first machine learning system may then use the first preference 912 received for the displayed images to calculate and/or create a first preference score 914.

The first learning machine 904 may then select a second set of objects 905 from the object database according to the first preference score 914. The object images 908 associated with the second set of retrieved objects 905 may then be displayed to the first user device 910 so that additional first user input and or first preference input 912 can be received and the first preference score can be updated and/or modified pursuant to the additional first preference input 912 received by the first machine learning system. In one embodiment, the first machine learning system may create a set of first selected objects 916 according to the first preference score 914, wherein the set of first selected objects comprises the objects that are consistent with the user's likes and dislikes and/or include object features that the first preference 912 indicated were liked by the first user. In at least one embodiment, the set of first selected objects includes all the objects retrieved from the object database 902. In alternate embodiments, the set of first selected objects 916 may include less than all the objects retrieved from the object database and could include for example only the objects for which a first user input 912 regarding the object images 908 indicated the user's like or preference for the object or object feature depicted.

In at least one embodiment, the first machine learning system can rank the objects in the set of first selected objects 916 so that the objects associated with the highest number of first preferences indicating the user liked an object or object feature depicted in the object image 908 are ranked the highest and the objects associated with the lowest number of first preferences 912 indicating the user liked an object or object feature depicted in the object image 908 are ranked the lowest. In alternate embodiments, certain object features may be given greater weight than other object features such that preferences relating to the weighted object features will more greatly influence the ranking order than preferences associated with non-weighted object features.

In one embodiment, the first machine learning system can send the first preference score 914 and/or the set of first selected objects 916 to a second machine learning system 920. The second machine learning system can display object images 922 associated with the set of first selected objects 914 to a second user device 924 so that a second user may provide, via the second device 924, a second preference 926 for one or more of the object images 922 displayed.

Alternatively, the second learning machine 902 could select a third set of objects from the object database according to the first preference score, wherein the third set of objects comprises objects that the machine learning system has determined are consistent with the first preference score. The second machine learning system may then display object images 922 associated with the objects in the third set of objects retrieved from the object database so that the user may provide a second preference associated with one or more of the object images displayed.

Once the second preference is received for either the first set of selected objects 916 or the third set of objects 918 retrieved from the object database, the second machine learning system 920 may calculate and/or create a second preference score 928 according to the second preference 926 received. The second machine learning system 920 may then create a set of second selected objects 930 according to the second preference score 928. In at least one embodiment the set of second selected objects only includes objects associated with an object image for which a second preference was received. In at least one embodiment, the second machine learning system 920 may create a set of third selected objects 932 according to the aggregate of the first preference score 914 and the second preference score 928. In one embodiment, the set of third selected objects 932 may include all the objects in the set of first set of selected objects 916. In alternate embodiments, the set of third selected objects 932 may include only those objects from the set of first selected objects for which the second preference 926 indicates that the second user likes the object or a feature of the object depicted in the object image 922. In yet another embodiment, the set of third selected items could some or all the objects from the set of first selected objects 916 and the third set of objects 918 retrieved from the database.

In at least one embodiment objects in the set of third selected objects can be ranked in much the same way as the objects in the set of first selected objects are ranked, wherein the objects associated with the highest number of first and second preferences indicating both the first user and the second user liked an object or object feature depicted in the object image 922 are ranked the highest and the objects associated with the lowest number of first and second preferences indicating the both the first and the second user liked an object or object feature depicted in the object image 908 are ranked the lowest. Again, certain object features may be weighted so that preferences associated with the weighted features will have a greater effect on the ranking order.

Referring now to FIG. 10, the process by which two or more users can submit preferences for objects independently selected and/or preferred by the users is described. Much like the system described in FIG. 9, this embodiment includes a first machine learning system 1004 is in communication with an object database 1002, which is housed in an object server 1000. The first machine learning system may retrieve a first set of objects 1003 from the object database 1002 according to a set of first user selection criteria 1006 received by the first machine learning system 1004. Alternatively, the first machine learning system may randomly select the first set of objects from the object database. The first machine learning system may then display to a first device 1010 object images 1008 associated with the retrieved objects. A first user may then provide a first user input 1012 via the first device. Such input may constitute a first preference 1012, which may be input in any of the manners discussed herein or that would be generally known in the art. The first machine learning system 1004 may then use the first preference 1012 received for the displayed images 1008 to calculate and/or create a first preference score 1014.

The first learning machine 1004 may then select a second set of objects 1005 from the object database 1002 according to the first preference score 1014. The object images 1008 associated with the retrieved objects may then be displayed to the first user device 1010 so that additional user input and or first preference input 1012 can be received and the first preference score 1014 can be updated and/or modified pursuant to the additional first preference input 1012 received by the first machine learning system.

In one embodiment, the first machine learning system may create a set of first selected objects 1016 according to the first preference score 1014, wherein the set of first selected objects comprises the objects that are associated with object images 1008 for which a first preference indicates that the user likes the objects and/or object features depicted in the object images displayed. In at least one embodiment, the set of first selected objects 1016 includes all the objects retrieved from the object database 1002, including those included in the first set of retrieved objects 1003 and the second set of retrieved objects 1005. In alternate embodiments, the set of first selected objects may include less than all the objects retrieved from the object database and could include for example only the objects for which a first user input and/or first preference 1012 regarding the object images 1008 indicates the user's like or preference for the object or object feature depicted in the object images.

In at least one embodiment, the first machine learning system 1004 can rank the objects in the set of first selected objects 1016 so that the objects associated with the highest number of first preferences indicating the user liked an object or object feature depicted in the object image 1008 are ranked the highest and the objects associated with the lowest number of first preferences 1012 indicating the user liked an object or object feature depicted in the object image 1008 are ranked the lowest. Again, a weighted ranking system may be used for this purpose.

In the shown embodiment, the system further includes a second machine learning system 1020 that is communication with the object server 1000 and the object database 1002. The second machine learning system may retrieve a third set of objects 1017 from the object database according to a set of second user selection criteria 1018 received by the second machine learning system 1020. Depending on the similarity between the first user selection criteria 1006 and the second user selection criteria 1018, the third set of retrieved objects 1017 could include the same objects as those included in the first set of objects 1003 retrieved by the first machine learning system. In another embodiment, the third set of retrieved objects 1017 could contain some of the same objects or none of the same objects as those included in the first set of retrieved objects 1003. Alternatively, the second machine learning system 1020 may randomly select the third set of objects 1017 from the object database. The second machine learning system may then display, to either the first device 1010 or a second device 1024, object images 1022 associated with the retrieved objects. A second user may then provide a second user input 1026, which may be a second preference 1026, via either the first device 1010 or the second device 1026, depending on which device the second user is utilizing to review the object images 1022. The second preference 1026 may be input in any of the manners discussed herein or that would be generally known in the art. The second machine learning system 1020 may then use the second preference 1026 received to calculate and/or create a second preference score 1028.

The second learning machine 1020 may then retrieve a fourth set of objects 1019 from the object database according to the second preference score 1028. The object images 1022 associated retrieved objects may then be displayed to either a first user device 1010 or a second user device 1024 so that additional second user input and or second preference input 1026 can be received and the second preference score 1028 can be updated and/or modified pursuant to the additional second preference input 1026 received by the second machine learning system. In one embodiment, the second machine learning system may create a set of second selected objects 1030 according to the second preference score 1028, wherein the set of second selected objects may comprise all the objects retrieved by the second machine learning system from the object database 1002 or less than all the retrieve objects such that only the objects for which a second user input and or second preference 1026 regarding the object images 1022 indicated the user's like or preference for the object feature. In at least one embodiment, the second machine learning system 1004 can rank the objects in the set of second selected objects 1030 in much the same way as the set of first selected objects 1016 is ranked.

In the shown embodiment, the invention further includes a third machine learning system 1032 that may receive the first preference score 1014 and the second preference score 1028 as well as the set of first selected objects 1016 and the set of second selected objects 1030. The third machine learning system may then display, to the first user device 1010, object images 1034 associated with the set of second selected objects 1030 and receive a third preference 1038 from the first user device 1010, wherein such third preference relates to the displayed object images 1034. The third machine learning system 1032 may also display, to either the first device 1010 or to the second device 1024, object images 1036 associated with the set of first selected objects 1016 so that a second user may provide a fourth preference 1040 regarding the displayed images 1036.

Upon receiving the third and fourth preferences, the third machine learning system may then calculate a third preference score 1042 according to the third preference 1038 and the fourth preference 1040. The third machine learning system may then create a set of third selected objects 1044, which may include all or less than all the objects contained in the set of first selected objects 1016 and the set of second selected objects 1030. The set of third selected objects 1044 may be ranked according to the third preference score so that objects associated with object images having the highest number of first and second user preferences indicating that both the first and second user like the object or the object feature depicted in the object image is ranked the highest. Again, a weighted ranking system may be used for this purpose.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on” and/or “based, at least in part, on.” Similarly, the phrase “according to” does not mean “according only to” unless expressly specified otherwise. In other words, the phrase “according to” describes both “according only to” “according at least to” and “according, at least in part, to.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The methods disclosed herein comprise one or more steps or actions for achieving the described methods. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computerized system for determining common interest using image-based user preferences comprising:
a server having an object database wherein each object represented in the object database is associated with a plurality of object images wherein each object image represents an attribute of the object;
a first machine learning system in communications with the server and adapted to receive a set of selection criteria, retrieve a first set of objects from the object database, display a first set of object images, receive a first preference for at least one of the images in the first set of object images displayed, determine a first preference score according to the first preference received, create a set of first selected objects according to a first preference score, provide the first preference score to a second machine learning system; and,
wherein the second machine learning system is adapted to display the first set object images, receive a second preference for at least one of the images in the first set of object images displayed, determine a second preference score according to the second preference received for at least one image in the first set of object images, create a set of second selected objects according to the first preference score and the second preference score, wherein the set of second selected objects represents objects for which the first preference and the second preference are consistent.

2. The computerized system of claim 1 wherein the first machine learning system is adapted to assign a first ranking to each of the objects within the set of first selected objects according to the first preference score.

3. The computerized system of claim 1 wherein the second machine learning system is adapted to assign a second ranking to each of the objects within the set of first selected objects according to the second preference score.

4. The computerized system of claim 1 wherein the second machine learning system is adapted to assign a third ranking to each of the objects within the set of second selected objects according to an aggregate of the first preference score and the second preference score.

5. The computerized system of claim 1 wherein the objects are physical structures and the images are images of at least a portion of a room in the physical structure.

6. The computerized system of claim 1 wherein one of the first preference and the second preference is determined according to a swipe.

7. The computerized system of claim 1 wherein one of the first preference and the second preference is determined according to the length of time elapsed between when a first image of the first set of object images is displayed and when a user input is received for the first image.

8. A computerized system for determining common interest using image-based user preferences comprising:
a processor;
memory;
instructions stored in the memory that when executed by the processor cause a first machine learning system to:
display a first set of images wherein the first set of images comprises a plurality of images, each of which is associated with a feature of a physical object,
receive a first preference ate least one image in the first set of images displayed,
determine a first preference score according to the first preference received,
provide to a second learning system the first set of images and the first preference score; and,
instructions stored in the memory that when executed by the processor cause the second machine learning system to
display the first set of images,
receive a second preference for at least one image of the first set of images displayed,
determine a second preference score according to the second preference received,
order the images in the first set of images according to the first preference score and the second preference score.

9. The computerized system of claim 8 wherein the order of the images in the first set of images is determined, at least in part, according to a consistency between the first preference and the second preference.

10. The computerized system of claim 8 wherein the objects are physical structures and the images are images of at least a portion of one room in the physical structure.

11. The computerized system of claim 8 wherein one of the first preference and the second preference is determined according to a swipe.

12. The computerized system of claim 8 wherein one of the first preference and the second preference is determined according to the length of time elapsed between when a first image of the plurality of images is displayed and when a user input is received for the first image.

13. The computerized system of claim 1 wherein the first machine learning system is adapted to assign a first ranking to each of the objects associated the set of first set of images according to the first preference score and wherein the second machine learning system is adapted to assign a second ranking to each of the objects associated with the set of first set of images according to the second preference score.

14. A computerized system for determining interest using image-based user preferences comprising:
a server having an object database wherein each object represented in the object database is associated with a set of object images wherein each object image represents an attribute of the object; and,
a first machine learning system in communications with the server and adapted to:
receive a set of selection criteria,
retrieve a first set of objects from the object database,
display a first set of images associated with the first set of objects,
receive a first preference for each image in the first set of images displayed,
determine a first preference score according to the first preference received,
select a second set of objects according to the first preference score,
display a second set of images associated with the second set of objects,
receive a second preference for each image in the second set of images displayed,
determine a second preference score according to the second preference received, and,
create a set of selected objects according to the second preference score and the first preference score, wherein the set of selected objects represents objects for which the first preference and the second preference are consistent.

15. The computerized system of claim 14 wherein the set of selection criteria received by the first machine learning system is modified according to the first preference score so that the objects retrieved in response to the selection criteria are retrieved, at least in part, according to the first preference received by the first machine learning system.

16. The computerized system of claim 14 wherein the set of selection criteria is modified according to the similarities in the first preference and the second preference so that the objects retrieved in response to the selection criteria are retrieved, at least in part, according to the first preference and the second preference.

17. The computerized system of claim 14 wherein one of the first preference and the second preference is determined according to a swipe.

18. The computerized system of claim 14 wherein one of the first preference and the second preference is determined according to the length of time elapsed between when an image of the first set of images is displayed and when a user input is received for the displayed image.

19. The computerized system of claim 14 wherein the first machine learning system is adapted to assign a first ranking to each of the objects associated the first set of images according to the first preference score and to assign a second ranking to each of the objects associated with the second set of images according to the second preference score.

20. The computerized system of claim 14 wherein the first machine learning system is adapted to rank the objects in the set of selected objects according to the first preference score and the second preference score.
